(19) United States
(12) Patent Application Publication
(10) Pub. No.: US 2025/0297692 A1
(43) Pub. Date: Sep. 25, 2025

(54) ROTARY ELECTRIC ACTUATOR

(71) Applicant: Trutorq Italia Srl, Brescia (IT)

(72) Inventors: Angelo Masserdotti, Brescia (IT); Matteo Prezioso, Bergamo (IT)

(21) Appl. No.: 18/751,844

(22) Filed: Jun. 24, 2024

(30) Foreign Application Priority Data
Mar. 25, 2024 (IT) 102024000006508
Jun. 3, 2024 (CA) 3240319

(51) Int. Cl. F16K 37/00

(52) U.S. Cl. CPC F16K 37/0025

(57) ABSTRACT

The present disclosure is a rotary electric actuator for a valve equipped with a shutter, comprising an electric motor, a pinion-equipped drive shaft, and an output shaft associated with the drive shaft. A plurality of intermediate shafts are arranged between the drive shaft and the output shaft, the intermediate shafts each having two toothed wheels to communicate rotation data between the output shaft, drive shaft, and among intermediate shafts. An electronic card is programmed to determine valve status and valve shutter position based on electronic signals received. A valve status indicator indicates the valve status based on the electronic signals. A valve shutter position detector continually detects the position of the valve shutter, is in communication with the electronic card to transmit electronic signals to the electronic card, and comprises at least a first encoder set to continuously detect angular change in the valve shutter position.

### REFERENCE TO RELATED APPLICATIONS

This application claims priority to Italian Patent Application 102024000006508, filed on Mar. 25, 2024, and Canadian Patent Application 3,240,319, filed on Jun. 3, 2024, the contents of which are both hereby incorporated by reference in their entirety.

### FIELD

The present disclosure relates to electric actuators and more specifically rotary electric actuators for automating industrial quarter-turn valves whose opening and closing is accomplished by rotation of approximately ninety degrees on their axis.

### BACKGROUND

An actuator is a system that converts an input power into an output torque capable of acting on a valve shutter.

There are different existing actuators-both pneumatic (which uses a pressurized fluid like gas or oil as an input) and electric (which uses electrical voltage as an input).

These actuators use the input to move a motor using gears to transfer rotational motion to an output shaft aligned with the axis to move the valve shutter.

Electric actuators are generally known and typically comprised of a motor, a drive shaft with pinion, an output shaft having a toothed wheel, a plurality of intermediate shafts each having two toothed wheels, an electronic card, a detector configured to detect two possible positions assumed by the valve shutter (corresponding to fully open and fully closed), and a visual indicator of the valve shutter status.

In the prior art the detection means is generally a type comprising a mechanical index (for example a cam) that cooperates with two sensors to detect the two extreme positions assumed by the valve shutter to determine the opened/closed state of the valve.

The prior art mechanical index can be replaced by a magnetic proximity sensor like that disclosed in Italian patent application no. 2017 0001 8345.

All of these prior art actuators have limitations and disadvantages.

One such limitation and disadvantage is that these traditional electric actuators can detect only the two end/extreme positions that the shutter can assume-opened and closed.

Rotation of the shutter is not constantly monitored in prior art actuators and so these actuators cannot know at any time any intermediate position that the valve shutter itself can assume (positions between opened and closed cannot be detected or conveyed to a user).

Another disadvantage of these known actuators is their low reading precision—reading of the valve shutter limit switch is entrusted only to a switch pressed by a mechanical index (like a cam) integral with the valve shutter limit switch output shaft.

Yet another limitation of the prior art electric actuators concerns difficulty in reading visual indicators of valve status in poor lighting conditions.

### SUMMARY

The present disclosure is a rotary electric actuator for an industrial valve that is precise, facilitates the control phases of the valve upon which the actuator is mounted.

The present disclosure detects in a constant and continuous manner the position of the valve shutter on which the actuator is mounted, by detecting angles between zero and ninety degrees rotation of the shutter itself.

The present disclosure also visually indicates in a constant and continuous manner the position of the valve shutter on which the actuator is mounted, by detecting angles between zero and ninety degrees rotation of the shutter itself.

The present disclosure includes an electric motor having an associated pinion-equipped drive shaft and a toothed wheel output shaft for connecting to a valve plug, there being a plurality of intermediate two toothed wheel shafts arranged between the drive and output shaft; and an electronic card associated with a valve status indicator and a shutter position detector wherein the shutter position detector comprises at least one encoder set to continuously detect variation in shutter angular position.

In a more specific embodiment the at least one encoder set comprises a magnet associated and rotatable with the output shaft, and a fixed encoding sensor facing the magnet and associated with the electronic board, where magnet rotation is read and transformed (encoded) by the sensor into an electrical signal corresponding to shutter rotation degree.

The magnet of the at least one encoder set is arranged at an output shaft end distal to the shutter.

Another embodiment of the present disclosure provides a second encoder set to detect the valve shutter position.

The second encoder set comprises a magnet associated and rotatable with one of the intermediate shafts, and a fixed encoding sensor facing that magnet and associated with the electronic board, where magnet rotation is read and transformed by the fixed encoding sensor into an electrical signal to control the degree of shutter rotation measured by the first encoder.

In one embodiment, the second encoder set magnet is arranged at an intermediate shaft end proximal to the electronic board.

In one embodiment, the second encoder set magnet is associated with an intermediate shaft not mechanically connected directly to the output shaft.

In another embodiment of the present disclosure the valve status indicator comprises light emitting diodes (LEDs) for visual status indication.

The LEDs can be arranged along a ninety degree arc wherein progressive LED illumination along the arc corresponds to shutter rotation degree measured by the at least one encoder.

The present disclosure distinguishes over prior art actuators by permitting continual determination of valve shutter position and consequently integral valve position.

The present disclosure also distinguishes over the prior art by using electronic measurement over mechanical measurement.

The valve shutter position is determined by a double reading, meaning by reading the number of revolutions of two non-successive shafts such as the output shaft to which the valve shutter is integral and one of the intermediate shafts.

This double reading resolves mechanical coupling errors, plays, and tolerances that prior art cam-based actuators are unable to resolve because of mechanical coupling limitations.

Moreover, the combined upstream reading of the output shaft allows more precise resolution compared to the present disclosure.

The measurement precision and repeatability of the encoders in the present disclosure allow for measurement data to be two orders of magnitude more precise than prior art actuators.

The present disclosure provides a mechanism for indicating the state of a valve that is advantageously very intuitive and easily interpreted by an operator who can, even in low light conditions, appreciate intermediate positions assumed by the shutter.

### BRIEF DESCRIPTION OF THE DRAWINGS

FIG. 1 is an axonometric view of a rotary electric actuator for industrial valves according to the present disclosure.

FIG. 2 is an exploded axonometric view from above of a rotary electric actuator for industrial valves according to the present disclosure.

FIG. 3 is an axonometric view from below of a rotary electric actuator for industrial valves according to the present disclosure.

FIG. 4. is an axonometric lateral view of a rotary electric actuator for industrial valves according to the present disclosure.

FIG. 5 is a cross-section view along the lines 5-5 of the actuator shown in FIG. 1.

FIG. 6 is an exploded axonometric view of an interface part of the actuator shown in FIG. 1.

### DETAILED DESCRIPTION

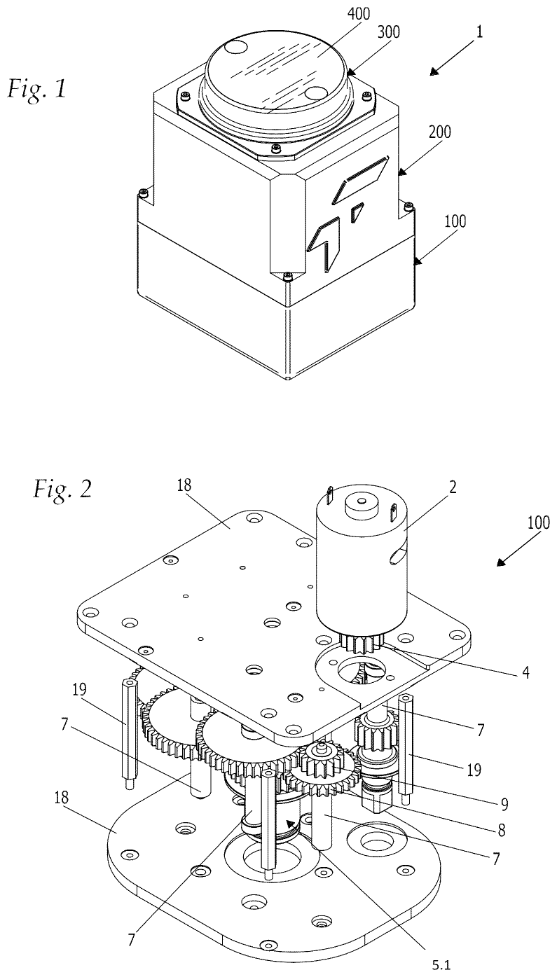

FIG. 1 generally shows a rotary electric actuator (1) for the automation of industrial valves of the type comprising a shutter operated by a shaft rotating the shutter between zero and ninety degrees.

The actuator includes three compartments: a mechanical compartment (100) that substantially includes an electric motor and toothed gearing wheels, to transform engine power to the output shaft that is in turn connected to the valve shutter.

A compartment (200) electronically governs the actuator, and an interface compartment (300), closed within a transparent cover (400) allows communication with an operator.

Referring to FIGS. 2 through 4, the compartment (100) of actuator (1) is shown (without a cover or casing) being between two metal support plates (18) bolted with stabilizing hexagonal pillars (19).

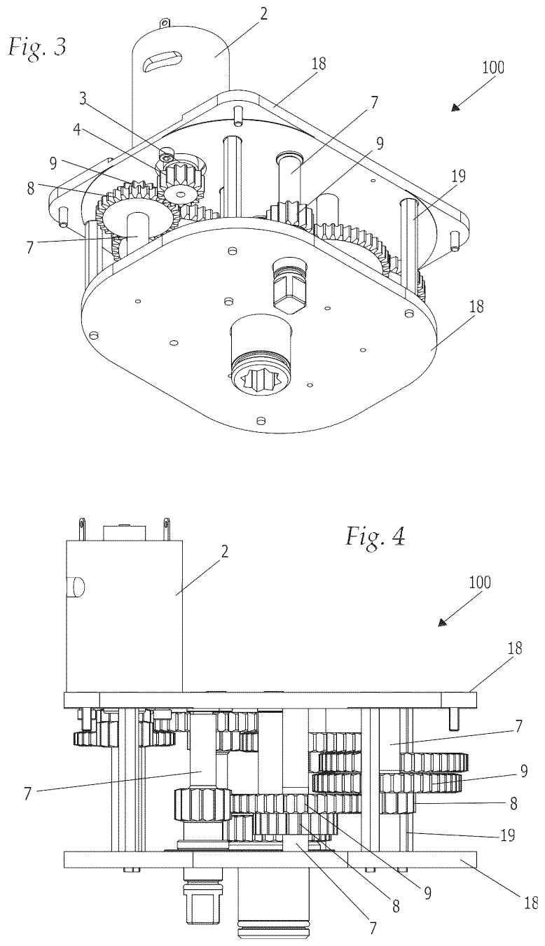

In addition to the electric motor (2), contained between the two support plates (18) is a drive shaft (3) (see FIG. 3) having a pinion (4) (see FIGS. 2 and 3).

There is also an output shaft (5) (see FIG. 5), suitable for being connected to an obturator (coupling) and having a toothed wheel (6).

There are a plurality of intermediate shafts (7) (FIGS. 3 and 4) arranged between the drive shaft (3) and the output shaft (5), each being provided with two toothed wheels (8, 9).

The plurality of intermediate shafts (7) are disposed generally in a manner such that they form a series of intermediary connections or engagements between the drive shaft (3) and the output shaft (5).

Most intermediate shafts (7) do not make direct contact with either of the drive shaft (3) and the output shaft (5) as discussed below.

Only one specific intermediate shaft (7) will directly contact the drive shaft (3) via toothed wheel (6) engagement while another different and specific intermediate shaft will directly contact the output shaft (5).

FIG. 5 illustrates in cross-section, the mechanical compartment (100) of the actuator surmounted by an electronic card (500) that is part of the electrical compartment (200).

The electronic card (500) is a modular card allowing flexibility of use under differing operating conditions including differing input electrical currents.

The electronic card (500) is programmed with software to process and convert electronic data into valve shutter rotational data for display through a valve status indicator.

The actuator (1) includes a valve shutter position detector for detecting the angular position of the toothed wheel (6) upon which the actuator acts.

The valve shutter position detector comprises a first encoder set (11) (FIG. 5) capable of continuously detecting the variation in position assumed by the shutter.

The first encoder set (11) includes a magnet (12) associated and rotatable with the output shaft (5).

The first encoder set (11) also includes a fixed encoding sensor (13) associated with and disposed beneath, the electronic board (500) so as to face the magnet (12).

The magnet (12) of the first encoder set (11) is arranged at one end of the output shaft (5) distal to the valve shutter and proximal to the electronic board (500).

The first encoder set (11) magnet (12) and sensor (13) are situated in near proximity to one another.

The rotation of the magnet (12) is read and transformed by the encoding sensor (13) into an electrical signal corresponding to a certain degree of rotation of the valve shutter (rotation data), thus indicating the valve state (in terms of rotation degree).

The valve shutter position detector can include a second encoder set 14 (see FIG. 5) arranged in correspondence with one of the aforementioned intermediate shafts (7).

The second encoder set (14) is suitable for measuring the number of revolutions made by the intermediate shaft (7) with which the second encoder set (14) is associated, to generate an electrical signal to be combined and compared, for control and verification, with the signal generated by the first encoder set (11).

The second encoder set (14) intermediate shaft (7) is hereafter referred to as “select” or “selected” intermediate shaft (7) to separate and distinguish reference to other intermediate shafts (7) not directly associated with the second encoder set (14)

All intermediate shafts (7) are able to rotate through three hundred and sixty degrees or more.

Therefore, measurements detected by the second encoder set (14) are more precise than those detected by the first encoder set (11) resulting in the electronic board (500) generating a more precise valve shutter position signal.

The electronic board (500) is programmed with software to convert the electronic signals received from encoding sensors into degrees of rotation of a valve shutter ranging from zero degrees to ninety degrees.

The select (or selected) intermediate shaft (7) must satisfy at least two conditions.

The first condition is that the select intermediate shaft (7) is restricted from mechanically engaging or connecting directly to the output shaft (5).

Stated differently, a toothed wheel (6) or gear on the output shaft (5) is not directly engaging a toothed wheel (6)/gear on the select intermediate shaft (7).

The second condition is that the selected drive shaft (7) is also restricted from mechanically connecting directly to the drive shaft (3).

Stating the second condition differently, a toothed wheel (6) or gear on the drive shaft (3) is not directly engaging a toothed wheel (6)/gear on the selected intermediate shaft (7).

The second encoder set (14) includes a magnet (15) (see FIG. 5) rotatable with the selected intermediate shaft (7), and an encoding sensor (16) associated with the electronic board (500) and situated beneath the electronic board (500) thus facing the magnet (15) in near proximity.

The magnet (15) is arranged at one end of the selected intermediate shaft (7) proximal to the electronic board (500).

The rotation of the second encoder set (14) magnet (15) is read and transformed by the corresponding encoding sensor (16) into an electrical control signal of the degree of rotation of the valve shutter already measured by the first encoder set (11) through data processing software associated with and managed by the electronic card (500).

The electric actuator (1) includes a structure or device configured to indicate the valve state not only in the two extreme working positions (fully closed or fully opened as corresponding to zero and ninety degrees respectively), but also in intermediate positions corresponding to degrees of rotation of the valve shutter between zero and ninety degrees.

The valve status indicator to indicate the valve state (status) is provided in the interface compartment (300) beneath the transparent closing cover (400) of the electric actuator (1).

The valve status indicator for indicating the valve state is, in one embodiment, comprised of a light emitting diode (LED) visual indication mean.

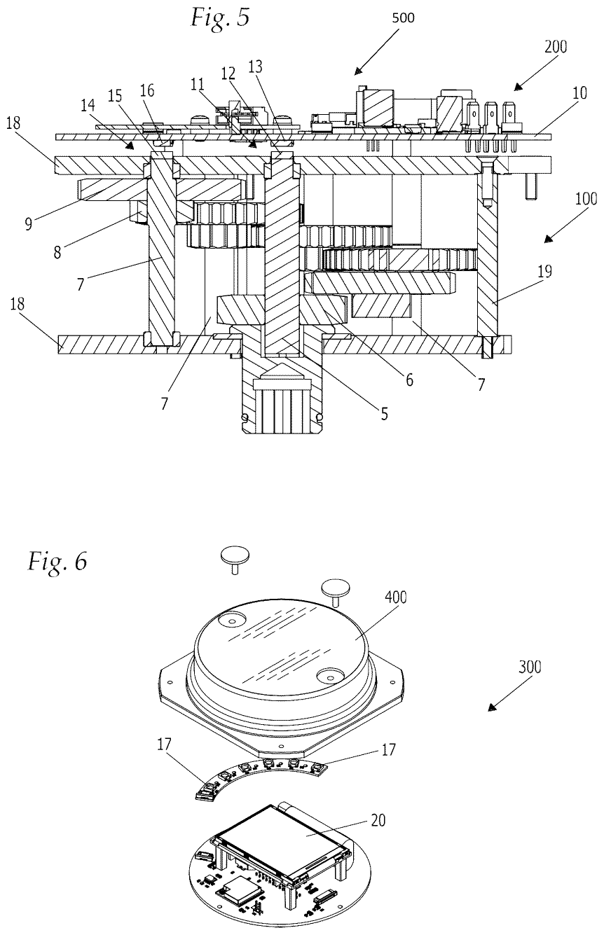

Referring to FIG. 6, the LED visual indicator comprises a plurality of LEDs (17) arranged along a ninety-degree arc such that progressive illumination of the LEDs (17) along the arc corresponds to the valve shutter rotation degree as measured from both the first (11) and second (14) encoders.

Beneath the cover (400) there is a liquid crystal display (LCD) screen (20) that allows both the reading of the real-time information (degrees of rotation) of the actuator (1) and control of the same (for example by maintenance operations).

The interface compartment (300) can also be equipped with systems for establishing a global computer network connection, such as the Internet, through a wireless-fidelity (WI-FI) connection to a local device (such as a smartphone or computer tablet) or via a local access network (LAN) line to a computer device or network.

The interface component (300) processes externally-received information and routes same to the electronic card (500) input-receiving component, archives the events classifying them as an alarm or malfunction, controls and monitors the internal conditions to the actuator (1) both following an opening and closing command, and processes changes in the environment in which the actuator (1) is inserted.

The implementation of an application downloadable onto a smart phone or computer tablet provides a possible additional interface tool for operating and controlling the actuator, and is useful to facilitate and make information characterizing the actuator (1) easier for operators to understand (such as drive history, creation and resolution dates of alert messages, and choice of opening and closing valve angles).

What is claimed is:

1. A rotary electric actuator for an industrial valve equipped with a shutter, comprising:
i) an electric motor;
ii) a pinion-equipped drive shaft;
iii) an output shaft associated with the pinion-equipped drive shaft, the output shaft being connected to a valve plug, the output shaft having a toothed wheel;
iv) a plurality of intermediate shafts arranged between the drive shaft and the output shaft, the intermediate shafts each having two toothed wheels for gearing and to communicate rotation data between the output shaft, drive shaft, and among intermediate shafts;
v) an electronic card programmed to determine valve status and valve shutter position based on received electronic signals;
vi) a valve status indicator configured to indicate the valve status, the valve status indicator being in communication with the electronic card to display valve status based on the received electronic signals; and
v) a valve shutter position detector configured to continually detect a position of the shutter of the industrial valve, in communication with the electronic card to transmit electronic signals to the electronic card, and comprising at least one first encoder set to continuously detect angular change in the valve shutter position.

2. The rotary electric actuator in claim 1, wherein the at least one first encoder set comprises a magnet associated and rotatable with the output shaft, and a fixed encoding sensor facing the magnet to read and transform a magnet rotation into an electronic signal transmitted to the associated electronic card, wherein the magnet rotation is read and transformed by the fixed encoding sensor into the electronic signal for processing by the electronic card into a degree of rotation of the valve shutter for indication by the valve status indicator.

3. The rotary electric actuator in claim 2, wherein the first encoder set magnet is arranged at one end of the output shaft distal to the valve shutter.

4. The rotary electric actuator in claim 1, wherein the valve shutter position detector further comprises a second encoder set.

5. The rotary electric actuator in claim 4, wherein the second encoder set comprises a magnet associated and rotatable with a selected one of the intermediate shafts, and an associated fixed encoding sensor communicating with the electronic card and facing the selected intermediate shaft magnet, wherein a rotation of the intermediate shaft magnet is read and transformed by the associated fixed encoding sensor into an electronic signal to combine with a signal generated by the first encoder set to improve a valve shutter rotation measurement accuracy as measured by the first encoder set.

6. The rotary electric actuator in claim 5, wherein the second encoder set magnet is disposed at one end of the selected intermediate shaft proximal to the electronic card.

7. The rotary electric actuator in claim 5, wherein the second encoder set magnet is associated with the select intermediate shaft not directly mechanically connected to the output shaft.

8. The rotary electric actuator in claim 1, wherein the valve status indicator comprises a light emitting diode visual indicator.

9. The rotary electric actuator in claim 8, wherein the light emitting diode visual indicator is a plurality of light emitting diodes arranged along a ninety degree arc for progressive illumination of the light emitting diodes along the ninety degree arc to indicate a corresponding degree of valve shutter rotation measured by the at least one first encoder.
